(19) United States
(12) Patent Application Publication
(10) Pub. No.: US 2007/0176869 A1
(43) Pub. Date: Aug. 2, 2007

(54) Electro-optical device, driving method thereof, and electronic apparatus

(75) Inventor: Shin Fujita, Suwa-shi (JP)

Correspondence Address: OLIFF & BERRIDGE, PLC, P.O. BOX 19928, ALEXANDRIA, VA, 22320, US

(73) Assignee: SANYO EPSON IMAGING DEVICES CORPORATION, TOKYO (JP)

(21) Appl. No.: 11/640,838

(22) Filed: Dec. 19, 2006

(30) Foreign Application Priority Data
Feb. 2, 2006 (JP) 2006-25333

(51) Int. Cl. G09G 3/36

(52) U.S. Cl. 345/88

(57) ABSTRACT

An electro-optical device which has a display region including a plurality of pixels each of which has a plurality of sub-pixels displaying different monochromes, the sub-pixels having scan lines, data lines, pixel electrodes and switching elements arranged at intersections of the scan lines and the data lines. The electro-optical device includes: a data line driving circuit that drives the data lines, wherein the plurality of pixels is constituted by the sub-pixels that are arranged in two or more rows in a direction that the data lines extend and in two or more columns in a direction that the scan lines extend, wherein the data line driving circuit has a demultiplexer having a plurality of output terminals relative to one input terminal and connecting the selected output terminal of the plurality of output terminals to the input terminal so that it distributes image signals supplied as time division signals to the data lines.

### BACKGROUND

1. Technical Field

The present invention relates to an electro-optical device such as a liquid crystal display device, a driving method thereof, and an electronic apparatus.

2. Related Art

A known example of an electro-optical device is a liquid crystal display device. The electro-optical device comprises, for example, a first substrate, a second substrate installed so as to be opposite thereto, a liquid crystal installed between the first substrate and the second substrate, and a backlight installed on the side of the second substrate furthest from the first substrate.

The first substrate comprises a plurality of scan lines, a plurality of common lines, a plurality of data lines, and a plurality of pixel transistors and pixel electrodes arranged at intersections of the scan lines and the data lines. Further, a common electrode is installed on the first substrate side of the second substrate.

Also, on the first substrate a scan line driving circuit that drives the scan lines, a data line driving circuit that drives the data lines, and a common line driving circuit that drives the common lines are installed.

In the electro-optical device as above, for example, on the first substrate side of the second substrate a display region having a plurality of pixels is formed. Each pixel is constituted by a plurality of sub-pixels that display different monochromes. More specifically, the pixels are constituted by sub-pixels that display three colors of red, green, and blue, for example.

Recently, however, since improvement of color reproduction is required, there has been proposed a configuration of sub-pixels that display other colors such as cyan or yellow, in addition to the sub-pixels that display the three colors of red, green, and blue (see JP A-2005-234133). In JP-A-2005-234133, these sub-pixels, for example, are arranged in a straight line, that is, in a stripe formation in a direction that the scan lines extend.

Further, the data line driving circuit is constituted by a plurality of demultiplexers, for example. Each demultiplexer has one input terminal and a plurality of output terminals, wherein the plurality of output terminals are sequentially selected by a switching element to be connected to the input terminal. As a, result, the demultiplexer distributes image signals supplied as time division signals from a signal source to the data lines.

In the case of constituting the pixel with the four sub-pixels of different colors formed by adding one sub-pixel to the three sub-pixel of different colors as in the electro-optical device of JP A-2005-234133, in order to secure the same precision as the case of forming the pixel with the three sub-pixels of different colors as in the related art, it is necessary to maintain the number of pixels arranged in the scan line direction. For this reason, it is necessary to increase the number of sub-pixels arranged in the scan line direction to 4/3 times that in the case of the pixel with three sub-pixels of different colors, that is, to reduce the dimension in the scan line direction of each sub-pixel to 3/4 times, that in the case of the pixel with the three sub-pixels of different colors.

However, since the sub-pixels are arranged in a stripe formation in the electro-optical device of JP A-2005-234133, four data lines for the respective pixels are arranged. For this reason, although reduction of the dimension of each sup-pixel in the scan line direction to 3/4 times that in the case of the pixel with three sub-pixels of different colors has been attempt, this reduction actually leads to problems regarding the layout of pixel transistors and leads to limitations on the narrowing of the width of data lines and the miniaturization of demultiplexers, making it difficult to realize such a configuration. As a result, realization of high-precision display is difficult.

Also, in the case that the dimension of each sub-pixel in the scan line direction is reduced to 3/4 times that in the case of the pixel with the three sub-pixels of different colors, it has been shown that the aperture ratio of the pixel becomes degraded.

### SUMMARY

An advantage of some aspects of the invention is to provide an electro-optical device, a driving method thereof, and an electronic apparatus capable of preventing deterioration of the aperture ratio of a pixel and providing a high precise display, even when the pixel is constituted by the sub-pixel of four or more colors.

According to an aspect of the invention, there is provided an electro-optical device having a display region constituted by a plurality of pixels that is constituted by a plurality of sub-pixels each displaying different monochromes, the sub-pixels having scan lines, data lines, pixel electrodes and switching elements arranged at intersections of the scan lines and the data lines. Here, the electro-optical device further includes: a data line driving circuit that drives the data lines, wherein the plurality of pixels is constituted by the sub-pixels that are arranged in two or more rows in a direction that the data lines extend and in tow or more columns in a direction that the scan lines extend, wherein the data line driving circuit comprises a demultiplexer having a plurality of output terminals relative to one input terminal and connecting the selected output terminal of the plurality of output terminals to the input terminal so that it distributes image signals supplied as time division signals to the data lines.

The respective pixels are constituted by arranging the sub-pixels in two or more rows in a direction that the data lines extend and in two or more columns in a direction that the scan lines extend. Therefore, in spite of the case constituting the pixel with the sub-pixels of four or more colors, it can prevent the increase of the number of sub-pixels arranged in a direction that the scan liens extend, that in the case in which the sub-pixels are arranged in a stripe shape as in the related art. For this reasons, it does not lead to a problem of a layout of the switching elements and does not need to make the width of the data lines narrow or to miniaturize the demultiplexers, thereby preventing deterioration of the aperture ratio of the pixel to realize a high precise display.

The electro-optical device according to an aspect of the invention comprises a scan line driving circuit supplying scan signals sequentially selecting the scan lines, wherein each of the plurality of pixels is constituted by the sub-pixels arranged in two columns in a direction that the scan lines extend and wherein it is preferable that the scan line driving circuit supplies scan signals at duty ratio of twice that in the case of the plurality of pixels by arranging the sub-pixels in one column in a direction that the scan lines extend.

The sub-pixels are arranged in two columns and thus, the duty ratio of the scan signals is twice, that in the case in which the sub-pixels are arranged in a stripe shape as in the related art. This is the reason that the number of the scan lines every one pixel becomes twice.

In the electro-optical device according to an aspect of the invention, it is preferable that the scan line driving circuit supplies the scan signals at 120 Hz.

According to another aspect of the invention, there is provided a method of driving an electro-optical device having a display region constituted by a plurality of pixels that is constituted by a plurality of sub-pixels each displaying different monochromes, the sub-pixels having scan lines, data lines, pixel electrodes and a switching element arranged at intersections of the scan lines and the data lines, the method including: constituting the plurality of pixels by arranging the sub-pixels in two or more rows in a direction that the data lines extend and in two or more columns in a direction that the scan lines extend; making one column as a first sub-pixel group and the other column as a second sub-pixel group among the sub-pixels in two columns arranged in a direction that the scan lines extend; supplying scan signals to the scan lines to make switching elements associated with the first sub-pixel group a conducting state and in this state, supplying image signals to the data lines to write them in pixel electrodes associated with the first sub-pixel group; and supplying scan signals to the scan lines to make switching elements associated with the second sub-pixel group a conducting state and in this state, supplying image signals to the data lines to write the them in pixel electrodes associated with the second sub-pixel group.

The respective pixels are constituted by arranging the sub-pixels in two or more rows in a direction that the data lines extend and in two or more columns in a direction that the scan lines extend. Therefore, although the pixel is constituted with the sub-pixels of four or more colors, it can prevent the increase of the number of sub-pixels arranged in a direction that the scan liens extend, that in the case in which the sub-pixels are arranged in a stripe shape as in the related art. For this reasons, it does not lead to a problem of a layout of switching elements and does not need to make the width of the data lines narrow or to miniaturize the demultiplexers, thereby preventing deterioration of the aperture ratio of the pixel to realize a high precise display.

In the driving method of the electro-optical device according to another aspect of the invention, it is preferable to constitute each of the plurality of pixels by arranging the sub-pixels in two columns in a direction that the scan lines extend and in the first sub-pixel group writing step and the second sub-pixel group writing step, to supply scan signals at duty ratio of twice in writing the first sub-pixel group and the second sub-pixel group, that in the case in which each of the plurality of pixels are constituted by arranging the sub-pixels in one column in a direction that the scan lines extend.

The sub-pixels are arranged in two columns and thus, the duty ratio of the scan signals is twice, that in the case in which the sub-pixels are arranged in a stripe shape as in the related art. This is the reason that the number of the scan lines every one pixel becomes twice rather than that of the related art.

The electro apparatus according to further aspect of the invention comprises the electro-optical device according to an aspect of the invention.

### BRIEF DESCRIPTION OF THE DRAWINGS

The invention will be described with reference to the accompanying drawings, wherein like numbers reference like elements.

FIG. 1 shows a block diagram of an electro-optical device 1 associated with the first embodiment of the invention;

FIG. 2 shows an arrangement of the sub-pixels 50 constituting the pixels P in the electro-optical device;

FIG. 3 shows a circuit diagram of the pixels and the demultiplexer unit circuit M corresponding to the pixels;

FIG. 4 shows a timing chart of the electro-optical device;

FIG. 5 shows circuit diagrams of pixels in an electro-optical device associated with the second embodiment according to the invention and a demultiplexer unit circuit corresponding to the pixels;

FIG. 6 shows circuit diagrams of pixels in an electro-optical device associated with the third embodiment according to the invention and a demultiplexer unit circuit corresponding to the pixels;

FIG. 7 shows a block diagram of the constitution of a liquid crystal panel of an electro-optical device associated with variations;

FIG. 8 shows a perspective view of the constitution of a mobile phone to which the electro-optical device as described above are applied.

### DESCRIPTION OF EXEMPLARY EMBODIMENTS

### First Embodiment

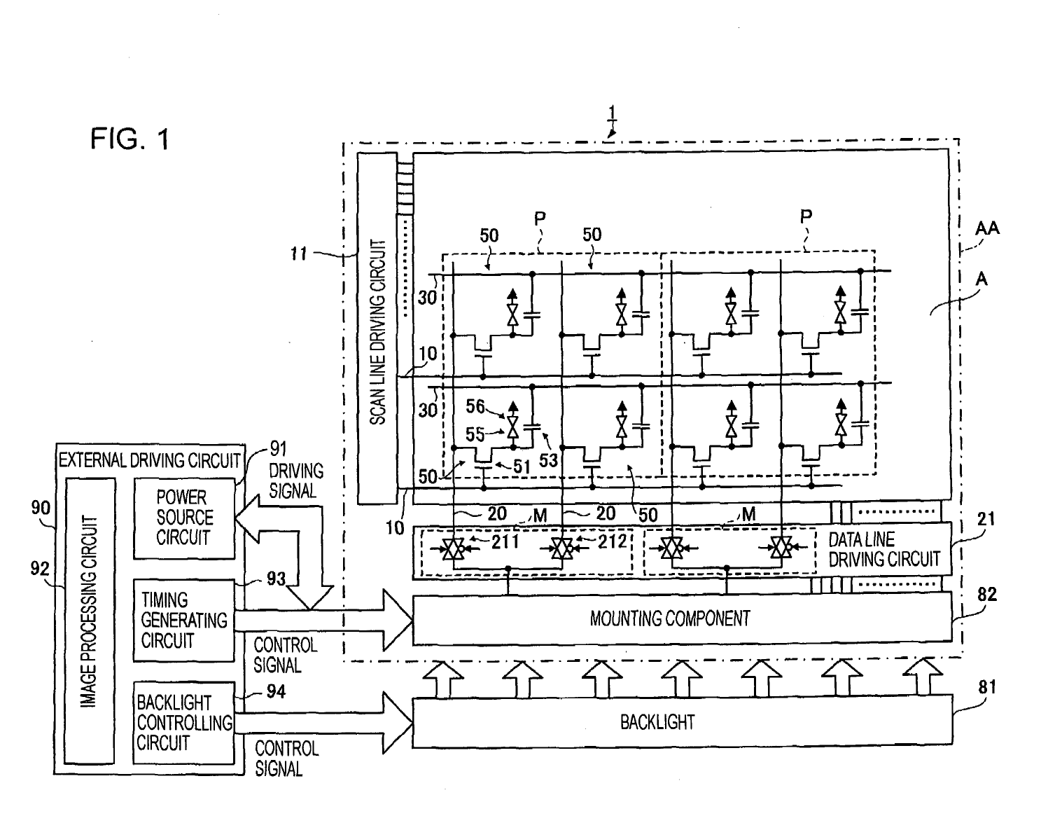

FIG. 1 shows a block diagram of an electro-optical device 1 associated with the first embodiment of the invention.

The electro-optical device 1 comprises a liquid crystal panel AA, an external driving circuit 90 driving the liquid crystal panel AA, and a backlight 81.

The liquid crystal panel AA comprises a display region A having a plurality of pixels P, and a scan line driving circuit 11 and a data line driving circuit 21 disposed outside of the display region A for controlling the pixels P. More particularly, the display region A has a rectangular shape, the scan line driving circuit 11 is installed along one side of the display region A, and the data line driving circuit 21 is installed along another side of the display region A, that is, adjacent to the side that the scan line driving circuit 11 is installed.

Also, a mounting component 82, which is an interface between the liquid crystal panel AA and the external driving circuit 90, is installed near the data line driving circuit 21.

The backlight 81 is installed on the rear side of the liquid crystal panel A, and, for example, is constituted by a cold cathode fluorescent lamp (CCFL) and a light emitting diode (LED) to emit light to the pixels P of the liquid crystal panel AA.

The external driving circuit 90 comprises a power source circuit 91 supplying power to the liquid crystal panel AA; an image processing circuit 92 supplying image signals to the liquid crystal panel AA; a timing generating circuit 93 outputting clock signals or start signals to the image processing circuit 92 liquid crystal panel AA; and a backlight controlling circuit 94 controlling the backlight 81.

The power source circuit 91 supplies driving signals to the liquid crystal panel AA to drive the scan line driving circuit 11 or the data line driving circuit 21, etc.

The image processing circuit 92, after performing gamma correction on the input image data considering the light-transmitting characteristic of the liquid crystal panel AA, performs digital-to-analogue conversion on image data of each color to generate image signals and to supply the image signals to the liquid crystal panel AA.

The timing generating circuit 93 is synchronized with the input image data input in the image processing circuit 92 to generate clock signals and start signals, and supplies them to the scan line driving circuit 11 or the data line driving circuit 21 on the liquid crystal panel AA. Also, the timing generating circuit 93 generates various timing signals to output them to the image processing circuit 92.

The backlight controlling circuit 94 outputs control signals controlling brightness to the backlight 81.

Hereinafter, the constitution of the liquid crystal panel AA will be described in detail.

The liquid crystal panel AA comprises a plurality of scan lines 10 and common lines alternately installed at a predetermined interval, and a plurality of data lines 20 installed at a predetermined interval that intersect with the scan lines 10 and the common lines 30. The pixels P are each constituted by four sub-pixels 50, and the sub-pixels 50 are arranged at intersections of the scan lines 10, the common lines 30, and the data lines 20.

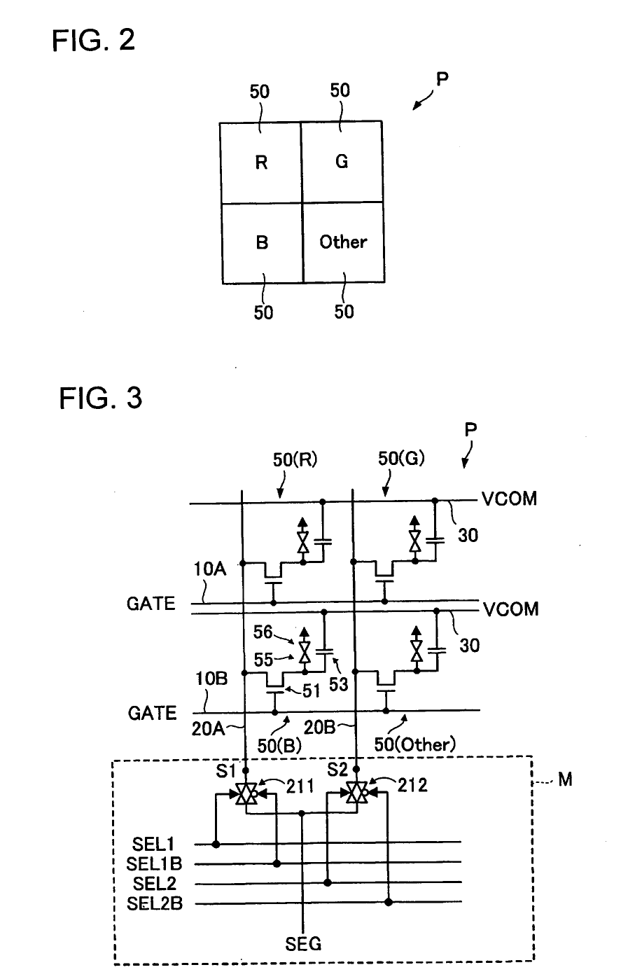

FIG. 2 shows an arrangement of the sub-pixels 50 constituting the pixels P.

For the pixels P, the sub-pixels 50 are arranged in two rows in a direction that the data lines 20 extend (right and left directions in FIG. 2), and in two columns in a direction that the scan lines 10 extend (up and down directions in FIG. 2).

Each pixel P is constituted by a plurality of sub-pixels 50 that display different monochromes. More particularly, each pixel P is constituted by the sub-pixels 50 that display colors of red R, green G, and blue B, and another color. In the top left part of FIG. 2 the sub-pixel 50 of red R is arranged, in the top right part of FIG. 2 the sub-pixel 50 of green G is arranged, in the bottom left part of FIG. 2 the sub-pixel 50 of blue B is arranged, and in the bottom right part of FIG. 2 the sub-pixel 50 of another color such as cyan or white is arranged.

Referring to FIG. 1, each of the sub-pixels 50 comprises a pixel transistor 51 as a switching element made of low-temperature poly silicon TFT; a pixel electrode 55; a common electrode 56 disposed opposite the pixel electrode 55; a capacitor 53, one end of which is electrically connected to the pixel electrode 55 and the other end of which is electrically connected to the corresponding one of the common lines 30.

The scan lines 10 are connected to the gate electrode of the pixel transistor 51, the data lines 20 are connected to the source electrode of the pixel transistor 51, and the pixel electrode 55 and the capacitor 53 are connected to the drain electrode of the pixel transistor 51. The liquid crystal is clamped between the pixel electrode 55 and the common electrode 56. Therefore, if a selecting voltage is applied from the scan lines 10, the pixel transistor 51 makes the data lines 20, the pixel electrode 55 and the capacitor 53 enter a conducting state.

The scan line driving circuit 11 supplies the selecting voltage which makes the pixel transistor 51 enter a conducting state, to each scan line 10 in line sequence. For example, if the selecting voltage is supplied to any one of the scan lines 10, all the pixel transistors 51 connected to the scan lines 10 enter the conducting state, and all the sub-pixels 50 connected to the scan lines 10 are selected.

The data line driving circuit 21 supplies image signals to each data line 20 to sequentially write the image data in the pixel electrode 55 of the sub-pixels 50 though the pixel transistor 51 in an on state. More particularly, the data line driving circuit 21 comprises a demultiplexer unit circuit M as a demultiplexer arranged so as to correspond to the columns of the pixels P, wherein each demultiplexer unit circuit M is constituted by including a pair of transfer gates 211 and 212. The demultiplexer unit circuit M distributes time division signals supplied from the external driving circuit 90 through a mounting component 82 to the data lines 20 of the corresponding sub-pixels 50 by opening and closing the transfer gates 211 and 212.

The electro-optical device 1 as above operates in the following manner.

By supplying the selecting voltage from the scan line driving circuit 1 in line sequence, all the sub-pixels 50 associated with any scan lines 10 are selected. By being synchronized with the selection of the sub-pixels 50, the image signals are supplied from the data line driving circuit 21 to the data lines 20. Thereby, the image signals are supplied to all the sub-pixels 50 selected from the scan line driving circuit 11 and the data line driving circuit 21 from the data lines 20 via the pixel transistor 51, so that the image signals are written in the pixel electrode 55.

If the image data are written in the pixel electrode 55 of the sub-pixels 50, a driving voltage is applied to the liquid crystal by means of a potential difference between the pixel electrode 55 and the common electrode 56. Therefore, by changing a voltage level of the image signals, the alignment or order of the liquid crystal is changed to execute gray scale display depending on the light modulation of each sub-pixel 50.

Also, the driving voltage applied to the liquid crystal is maintained over the period as many as three units longer than the period that the image data are written by means of the capacitor 53.

FIG. 3 shows a circuit diagram of pixels P and the demultiplexer unit circuit M corresponding to the pixels P.

Herein, the scan lines 10 in the upper part of FIG. 3 are referred to as 10A, and the scan lines 10 in the lower part of FIG. 3 are referred to as 10B. The scan signals GATE are supplied to the scan lines 10A and 10B. Also, the data lines 20 on the left side of FIG. 3 are referred to as 20A, and the data lines 20 on the right side of FIG. 3 are referred to as 20B. The driving signals VCOM are supplied to the common lines 30.

The demultiplexer unit circuit M, which is a 1:2 demultiplexer having one input and two outputs, has two output terminals S1 and S2 relative to one input terminal SEG and connects the output terminal selected from the two output terminals S1 and S2 to the input terminal SEG so that it distributes the image signals supplied as time division signals to the data lines 20A and 20B.

The demultiplexer unit circuit M has a first transfer gate 211 and a second transfer gate 212 formed of CMOS, which are complementary transistors. More particularly, the terminals on one side of the first transfer gate 211 and the second transfer gate 212 are connected to the input terminal SEG, and the terminals on other side thereof are connected to the output terminals S1 and S2. The output terminal S1 is connected to the data lines 20A associated with the sub-pixels 50 of red R and blue B, and the output terminal S2 is connected to the data line 20B associated with the sub-pixels 50 of green G and another color.

The selecting signals SEL1 and SEL1B are input to the control terminals of the first transfer gate 211. The selecting signal SEL1B is the inverted form of the selecting signal SEL1. If the selecting signals SEL1 and SEL1B enter an active state, the transfer gate 211 enters an on state so that the image signal input from the input terminal SEG is supplied to the data line 20A.

The selecting signals SEL2 and SEL2B are input to the control terminals of the second transfer gate 212. The selecting signal SEL2B is the inverted form of the selecting signals SEL2. If the selecting signals SEL2 and SEL2B enter an active state, the transfer gate 212 enters an on state so that the image signal input from the input terminal SEG is supplied to the data line 20B.

The multiple signals of the image data of red R, green G, blue B and other colors are input to the input terminal SEG.

The demultiplexer unit circuit M as described above operates in the following manner.

The demultiplexer unit circuit M allows the selecting signals SEL1 and SEL1B or the selecting signals SEL2 and SEL2B to enter an active state simultaneously with the supply of the image signals to the SEG. Thereby, the demultiplexer unit circuit M selects the data lines 20A associated the sub-pixels 50 of red R and blue B, or the data lines 20B associated with the sub-pixels 50 of green G and another color, enabling supply of the image signals to the selected data lines 20.

Next, the operation of the electro-optical device 1 will be described.

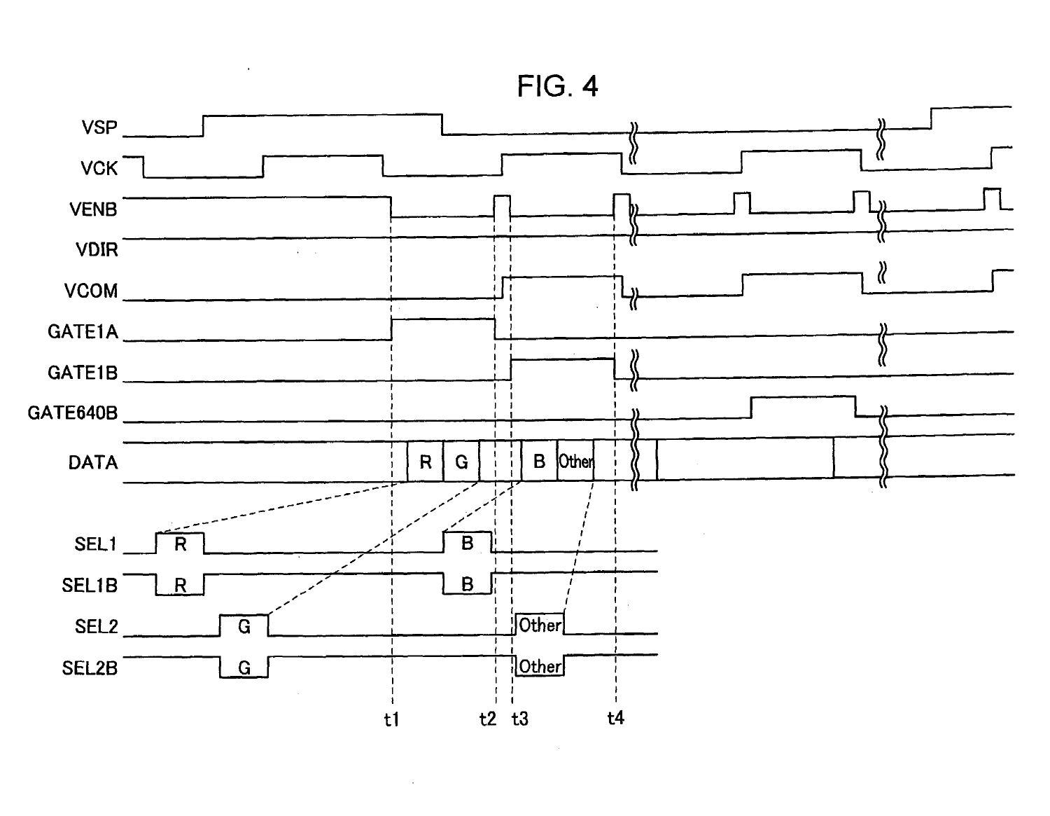

FIG. 4 shows a timing chart of an electro-optical device.

VSP is a start signal and VICK is a clock signal, and the VSP and the VCK are generated by a timing generating circuit 93 to be supplied to a liquid crystal panel AA.

VENB is a driving signal from a power source circuit 91. When the VENB is at low (L) level, a scan line driving circuit 11 is able to select scan signals GATE1 to 640 supplied to the scan lines.

VDIR is a signal used to define a scan direction. In the embodiment, the VDIR is always at high (H) level and is scanned from left to right in FIG. 1.

VCOM is a driving signal supplied to the common line 30, as described above. In the embodiment, a line inverting driving manner to invert the potential of a common electrode every one line is adopted so that the VCOM is inverted every one line.

GATE is a scan signal supplied to the scan line 10, as described above. In the embodiment, the number of the scan lines is 1280. GATE1A is a scan signal supplied to the scan line 10A in the top stage, and GATE1B is a scan signal supplied to the scan line 10B in the stage just below the top stage. Also, GATE640B is a scan signal supplied to the scan line 10B in the bottom stage. The scan signal GATE is supplied at a duty ratio twice, that is, at 120 Hz, that in the case in which each of the plurality of pixels is formed by arranging the sub-pixels in one column in a direction that the scan lines extend. DATA is a time divided image signal supplied to the data line driving circuit 21.

In time t1 to t2, VCOM is in a state of L level and the scan signal GATE1A is in a state of H level so that the sub-pixels 50 of red R and green G as a first sub-pixel group associated with the scan line 10A in the top stage are selected.

Also, the image data of red R and green G are continuously supplied to the demultiplexer unit circuit M as DATA by being synchronized with the selection of the sub-pixel 50. While the image data of red R are supplied, the selection signals SEL1 and SEL1B are in an active state, and the selecting signals SEL2 and SEL2B are in a non-active state. Also, while the image data of green G are supplied, the selecting signals SEL1 and SEL1B are in a non-active state, and the selecting signals SEL2 and SEL2B are in an active state.

Thereby, the image data of red R are supplied to the sub-pixel 50 of red R associated with the scan line 10A in the top stage via the data line 20A, and the image data of green G are supplied to the sub-pixel of green G associated with the scan line 10A in the top stage via the data line 20B.

Continuously, the VCOM is inverted to change from L level to H level. In this state, the scan signals GATE1B become H level and the sub-pixel 50 of blue B and other colors as second sub-pixel group associated with the stage just below the top stage are selected, in time t3 to t4.

Also, the image data of blue B and other colors are continuously supplied to the demultiplexer unit circuit M as DATA by being synchronized with the selection of the sub-pixels 50. While the image data of blue B are supplied, the selection signals SEL1 and SEL1B are in an active state, and the selecting signals SEL2 and SEL2B are in a non-active state. Also, while the image data of other colors are supplied, the selecting signals SEL1 and SEL1B are in a non-active state, and the selecting signals SEL2 and SEL2B are in an active state.

Thereby, the image data of blue B are supplied to the sub-pixels 50 of blue B associated with the scan signals GATE1B via the data lines 20A, and the image data of other colors are supplied to the sub-pixels of other colors associated with the scan signals GATE1B via the data lines 20B.

According to the embodiment, the invention has the following advantages.

(1) Each pixel P is constituted by arranging the sub-pixels 50 in two rows in a direction that the data lines 20 extend and in two columns in a direction that the scan lines 10 extend. Therefore, although the pixels P are constituted by the four or more sub-pixels and four or more colors, the invention can prevent an increase in the number of sub-pixels 50 arranged in a direction that the scan lines 10 extend, compared with the case in which the sub-pixels are arranged in a stripe formation in the related art. For this reason, the invention does not lead to problems regarding the layout of the pixel transistor 51 and does not require narrowing of the width of the data lines or miniaturization of the demultiplexer unit circuit M, thereby preventing deterioration of the aperture ratio thus realizing high-precision display.

### Second Embodiment

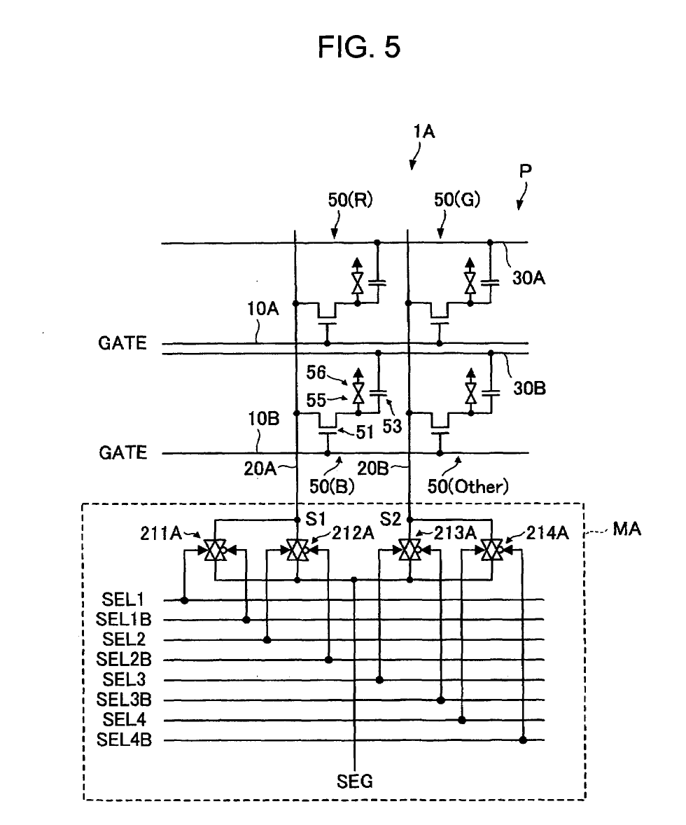

FIG. 5 shows circuit diagrams of pixels P in an electro-optical device 1A associated with the second embodiment according to the invention and a demultiplexer unit circuit MA corresponding to the pixels P.

In the embodiment, the constitution of the demultiplexer unit circuit MA is different from that in the first embodiment. Other constitutions are the same as those in the first embodiment.

In other words, the demultiplexer unit circuit MA, which is a 1:4 demultiplexer having one input and four outputs, has four transfer gates, a first to a fourth transfer gates 211A, 212A, 213A and 214A, constituted by CMOS. More particularly, in the demultiplexer unit circuit M, the terminals on one side of the first and the second transfer gates 211A and 212A are connected to an input terminal SEG, and the terminals on other side thereof are connected to an output terminal S1. Also, the terminal on one side of the third and the fourth transfer gates 213A and 214A are connected to the input terminal SEG, and the terminals on other side thereof are connected to the output terminal S2.

The selecting signals SEL1 and SEL1B are input to the control terminals of the first transfer gate 211A. The selecting signal SEL1B is the signal that the selecting signal SEL1 is inverted. If the selecting signals SEL1 and SEL1B become an active state, the transfer gate 211A becomes an on state, thereby supplying the image signal input from the input terminal SEG to the data line 20A.

The selecting signals SEL2 and SEL2B are input to the control terminals of the second transfer gate 212A. The selecting signal SEL2B is the signal that the selecting signals SEL2 is inverted. If the selecting signals SEL2 and SEL2B become an active state, the transfer gate 212A becomes an on state, thereby supplying the image signal input from the input terminal SEG to the data line 20A.

The selecting signals SEL3 and SEL3B are input to the control terminals of the third transfer gate 213A. The selecting signal SEL3B is the signal that the selecting signal SEL3 is inverted. If the selecting signals SEL3 and SEL3B become an active state, the transfer gate 213A becomes an on state, thereby supplying the image signal input from the input terminal SEG to the data line 20B.

The selecting signals SEL4 and SEL4B are input to the control terminals of the fourth transfer gate 214A. The selecting signal SEL4B is the signal that the selecting signals SEL4 is inverted. If the selecting signals SEL4 and SEL4B become an active state, the transfer gate 214A becomes an on state, thereby supplying the image signal input from the input terminal SEG to the data line 20B.

The demultiplexer unit circuit MA as above operates in the following manner.

The demultiplexer unit circuit MA allows the selecting signals SEL1 and SEL1B or the selecting signals SEL2 and SEL2B to become an active state simultaneously with supplying the image signals to the SEG. Thereby, the demultiplexer unit circuit MA enables to supply the image signals to the data lines 20A associated the sub-pixels 50 of red R and blue B. Also, the demultiplexer unit circuit MA allows the selecting signals SEL3 and SEL3B or the selecting signals SEL4 and SEL4B to become an active state. Thereby, the demultiplexer unit circuit MA enables to supply the image signals to the data lines 20B associated the sub-pixels 50 of green G and other colors.

According to the embodiment, the invention has the acting effects as shown in (1).

### Third Embodiment

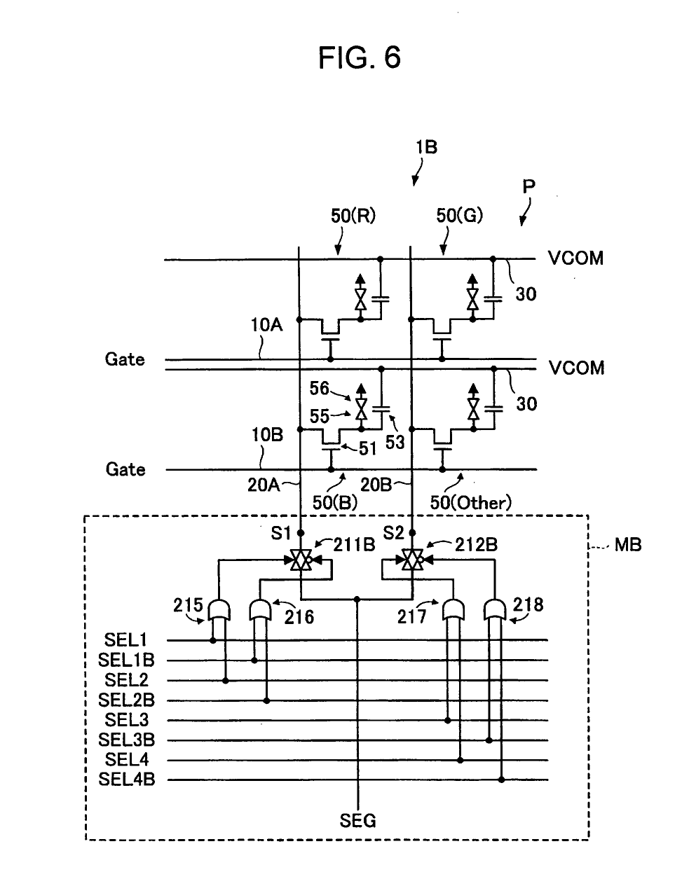

FIG. 6 shows circuit diagrams of pixels P in an electro-optical device 1B associated with the third embodiment according to-the invention and a demultiplexer unit circuit MB corresponding to the pixels P.

In the embodiment, the constitution of the demultiplexer unit circuit MB is different from that in the first embodiment. Other constitutions are the same as those in the first embodiment.

In other words, the demultiplexer unit circuit MA, which is a 1:4 demultiplexer having one input and four outputs, has first and second transfer gates 211B and 212B constituted by CMOS, and OR circuits 215, 216, 217 and 218.

More particularly, the selecting signals SEL1 and SEL1B are input to the OR circuit 215. If at least one of the selecting signals SEL1 and SEL2 becomes a state of H level, the OR circuit 215 outputs the signals of H level.

The selecting signals SEL1B and SEL2B are input to the OR circuit 216. The selecting signals SEL1B and SEL2B are the signals that the selecting signals SEL1 and SEL2 are inverted, respectively. If at least one of the selecting signals SEL1B and SEL2B becomes a state of H level, the OR circuit 216 outputs the signals of H level.

The selecting signals SEL3 and SEL4 are input to the OR circuit 217. If at least one of the selecting signals SEL3 and SEL4 becomes a state of H level, the OR circuit 217 outputs the signals of H level.

The selecting signals SEL3B and SEL4B are input to the OR circuit 218. The selecting signals SEL3B and SEL4B are the signals that the selecting signals SEL3 and SEL4 are inverted, respectively. If at least one of the selecting signals SEL3B and SEL4B becomes a state of H level, the OR circuit 218 outputs the signals of H level.

The terminals on one side of the first and the second transfer gates 211B and 212B are connected to the input terminal SEG, and the terminals on the other side thereof are connected to the output terminals S1 and S2, respectively.

The control terminals of the first transfer gate 211B are connected to the output end of the OR circuit 215 and the output end of the OR circuit 216, respectively. If the selecting signals SEL1 and SEL1B or the selecting signals SEL2 and SEL2B become an active state, the transfer gate 211B becomes an on state, thereby supplying the image signal input from the input terminal SEG to the data line 20A.

The control terminals of the second transfer gate 212B are connected to the output end of the OR circuit 217 and the output end of the OR circuit 218, respectively. If the selecting signals SEL3 and SEL3B or the selecting signals SEL4 and SEL4B become an active state, the transfer gate 211B becomes an on state, thereby supplying the image signal input from the input terminal SEG to the data line 20B.

The demultiplexer unit circuit MB as above operates in the following manner.

The demultiplexer unit circuit MB allows the selecting signals SEL1 and SEL1B or the selecting signals SEL2 and SEL2B to become an active state simultaneously with supplying the image signals to the SEG. Thereby, the demultiplexer unit circuit MB enables to supply the image signals to the data lines 20A associated the sub-pixels 50 of red R and blue B. Also, the demultiplexer unit circuit MB allows the selecting signals SEL3 and SEL3B or the selecting signals SEL4 and SEL4B to become an active state. Thereby, the demultiplexer unit circuit MB enables to supply the image signals to the data lines 20B associated the sub-pixels 50 of green G and other colors.

According to the embodiment, the invention has the acting effects as shown in (1).

### MODIFIED EXAMPLE

Also, the invention is not limited to the described preferred embodiments, but various changes and modifications thereof can be made within the scope to accomplish the aspects of the invention.

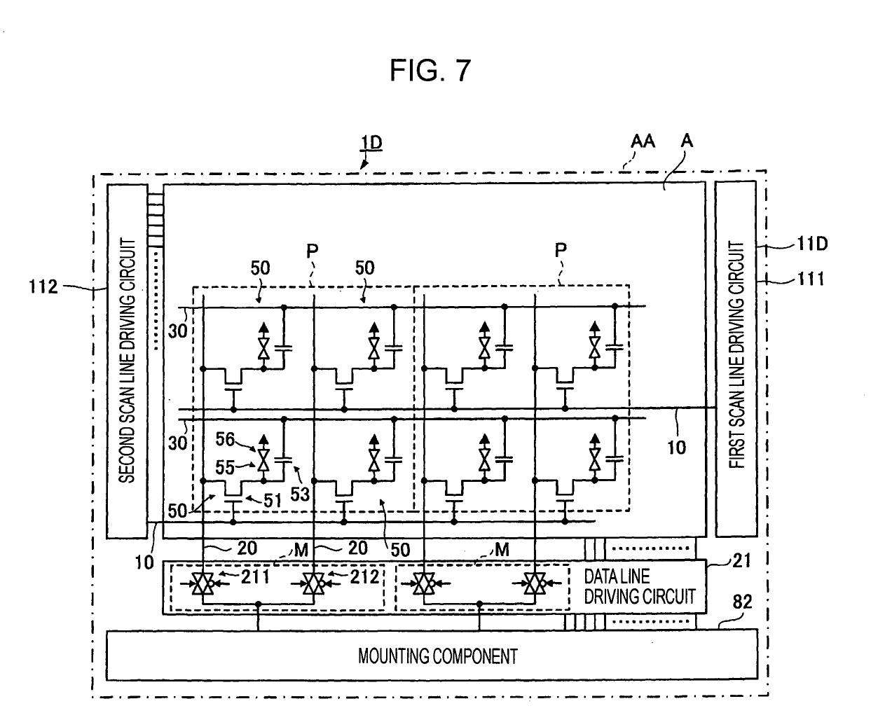

In the respective embodiments as described above, for example, the scan line driving circuit 11 is installed along one side of the display region A in a rectangular shape. However, not limiting thereto, the scan line driving circuit 11D may be installed along two opposite sides of the display region A in a rectangular shape, as shown in FIG. 7.

In other words, the scan line driving circuit 11D comprises a first scan line driving circuit 111 arranged in the right side in FIG. 7 and driving the scan lines 10 in the odd end, and a second scan line driving circuit 112 arranged in the left side in FIG. 7 and driving the scan lines in the even end.

According to this, the scan line driving circuit 11D is divided into two so that the scan lines 10 are selected by alternately driving the first scan line driving circuit 111 and the second scan line driving circuit 112, enabling to lighten the burden imposed on the scan line driving circuit.

Also, in the respective embodiments as described above, the pixels P are constituted of the sub-pixels 50 of four colors. However, not limiting thereto, the pixels P may be constituted by the sub-pixels of six colors or eight or more colors.

For example, if one pixel is constituted by arranging the sub-pixels of six colors in two rows and in three columns, the scan signals are supplied at the duty ratio of twice than the usual by using a 1:3 demultiplexer having one input and three outputs.

Also, for example, if one pixel is constituted by arranging the sub-pixels of six colors in two rows and in three columns, the scan signals are supplied at the duty ratio of three times than the usual by using a 1:2 demultiplexer having one input and two outputs or a 1:4 demultiplexer having one input and four outputs.

Also, in the respective embodiments as described above, the low temperature poly silicon TFT is used as the pixel transistor 51. However, not limiting thereto, amorphous silicon TFT may be used.

For example, in the respective embodiments as described above, the electro-optical device 1, 1A and 1B are constituted to perform a total reflection type display. However, not limiting thereto, they may are constituted to perform a transmission type display and to perform a transflective display, having a combination of transmission and reflection.

Also, in the respective embodiments as described above, the invention is applied to the electro-optical device 1, 1A and 1B using the liquid crystal as electro-optical material. However, not limiting thereto, the invention may be applied to electro-optical device using electro-optical material other than the liquid crystal. For example, the invention may identically be applied to various electro-optical device such as an organic EL display (OLED) panel using organic LED elements, an electrophoretic display panel using a microcapsule having colored liquid and the white particles dispersed in the liquid as electro-optical material, a twist ball display panel using a twist ball color-coded by coloring every region having different polarity with different colors as electro-optical material, a toner display panel using a black toner as electro-optical material, or a plasma display panel using high pressure gas such as helium or neon, etc. as electro-optical material, and so on.

Also, as the liquid crystal in the embodiment, twisted nematic (TN) liquid crystal or liquid crystal using negative dielectric constant may be used. Also, as a display mode of liquid crystal, in-plane switching (IPS) or fringe-field switching (FFS), etc. may be used.

Also, in the respective embodiments as described above, each sub-pixel 50 has each colored region and the pixels P is constituted of the sub-pixels 50 of four colors.

The colored regions of four colors are constituted of a colored region of colors of blue family, a colored region of colors of red family, and a colored region of two kinds of colors selected from blue to yellow, in a visible light region 380 to 780 nm that colors are changed in response to wavelengths.

Herein, although the family is used, for example, the colors of blue family include celadon or bluish green, etc., not purely being limited to blue. The colors of red family include orange, not being limited to red. Also, these colored regions may be constituted of a single colored layer or may be constituted by overlapping colored layers of plural different colors. Also, although these colored regions are described by means of colors, the colors may be set by properly changing chroma and brightness.

In other words, the sub-pixels 50 of red R, blue B, green G and other colors in the respective embodiments as described above are, for example, a colored region R of colors of red family R, a colored region B of colors of blue family B, and a colored region G and Other of two kinds of colors selected from blue to yellow.

As the range of the particular colors, the colored region of colors of blue family is from celadon to bluish green, and the colored region of colors of red family is from orange to red. The colored region of one side selected from blue to yellow is from blue to green, and more preferably from bluish green to green. The colored region of the other side selected from blue to yellow is from green to orange, and more preferably from green to yellow or green to bluish green.

Herein, each colored region does not use the same color. For example, in two colored regions selected in colors from blue to yellow, when colors of green family are used, the green is used in one side while colors of blue family or colors of yellowish green family are used in other side.

Thereby, the broader color reproduction than that of the colored regions of R, G and B in the related art, can be realized.

According to another particular example, the wavelengths transmitting the colored regions will be described hereinafter.

The colored region of colors of blue family is the colored region that the peak of wavelength is from 415 to 500 nm, and more preferably from 435 to 485 nm. The colored region of colors of red family is the colored region that the peak of wavelength is more than 600 nm, and more preferably more than 605 nm. The colored region of one side selected from blue to yellow is the colored region that the peak of wavelength is from 485 to 535 nm, and more preferably from 495 to 520 nm. The colored region of the other side selected from blue to yellow is the colored region that the peak of wavelength is from 500 to 590 nm, and more preferably from 510 to 585 nm or from 530 to 565 nm.

In the case of the transmission type display, the wavelength as above is the numerical value that the illuminating light from an illuminating apparatus is obtained through a color filter. In the case of the reflection type display, the wavelength as above is the numerical value that is obtained by reflecting external light.

For another particular example, the colorimetery of x and y will be displayed hereinafter.

The colored region of colors of blue family is the colored region having x≦0.151 and y≦0.200, and more preferably, 0.134≦x≦0.151 and 0.034≦y≦0.200. The colored region of colors of red family is the colored region having 0.520≦x and y≦0.360, and more preferably, 0.550≦x≦0.690 and 0.210≦y≦0.360. The colored region of one side selected from blue to yellow is the colored region having x≦0.200 and 0.210≦y, and more preferably, 0.080≦x≦0.200 and 0.210≦y≦0.759. The colored region of the other side selected from blue to yellow is the colored region having 0.257≦x and 0.450≦y, and more preferably, 0.257≦x≦0.520 and 0.450≦y≦0.720.

In the case of the transmission type display, the colorimetery of x and y as above is the numerical value that the illuminating light from the illuminating apparatus is obtained through a color filter. In the case of the reflection type display, the colorimetery of x and y as above is the numerical value that is obtained by reflecting external light.

The colored regions of these four colors can apply both a transmitting region and a reflective region in a range as described above, if the sub-pixels are provided with the transmitting region and the reflective region.

As the backlight 81, a LED as R, G and B light source, a fluorescent lamp and an organic EL as well as white light source may be used.

The white light source may be generated by means of light emitters of blue and Y, A and G phosphors.

Preferably, the R, G AND B light source has the following constitution. For B, the peak of the wavelength of the emitted light is from 435 to 485 nm. For G, the peak of the wavelength of the emitted light is from 520 to 545 nm. For R, the peak of the wavelength of the emitted light is from 610 to 650 nm. If the above described color filters are properly selected according to the wavelengths of the R, G and B light source, the broader color reproduction can be obtained.

Also, the light source having a plurality of peaks as the peaks of wavelengths of 450 nm and 565 nm may be used.

The followings can exemplify the constitution of the colored regions of four colors:
the colored regions of red, blue, green, and cyan (bluish green);
the colored regions of red, blue, green, and yellow;
the colored region of red, blue, dark green, and yellow;
the colored region of red, blue, emerald, and yellow;
the colored region of red, blue, dark green, and yellowish green; and
the colored region of red, bluish green, and yellowish green.

### APPLICATIONS

Next, the electronic apparatus to which the electro-optical device 1, 1A and 1B associated with the embodiments described as above are applied will be described.

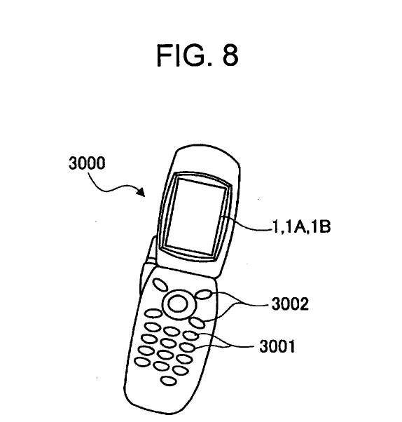

FIG. 8 shows a perspective view of the constitution of a mobile phone to which the electro-optical device 1, 1A and 1B are applied. The mobile phone 3000 comprises a plurality of operation buttons 3001 and scroll buttons 3002, and electro-optical device 1, 1A and 1B. The images displayed on the electro-optical device 1, 1A and 1B are scrolled by operating the scroll buttons 3002.

As the electronic apparatus to which the electro-optical device 1, 1A and 1B are applied, a personal computer, a personal digital assistant, a digital still camera, a liquid crystal TV, a viewfinder type and a monitor direct viewing type video tape recorder, a car navigation device, a pager, an electronic notebook, a calculator, a word processor, a workstation, a video phone, a POS terminal, and an apparatus having a touch panel, etc., may be included other than one shown in FIG. 8. The electro-optical device described as above is applicable as a display unit of such various electronic apparatus.

The entire disclosure of Japanese Patent Application No. 2006-25333, filed Feb. 2, 2006 is expressly incorporated by reference herein.

What is claimed is:

1. An electro-optical device having a display region including a plurality of pixels each of which has a plurality of sub-pixels displaying different monochromes, the sub-pixels having scan lines, data lines, pixel electrodes, and switching elements arranged at intersections of the scan lines and the data lines, the apparatus comprising:
a data line driving circuit that drives the data lines, wherein the plurality of pixels is constituted by the sub-pixels that are arranged in two or more rows in a direction that the data lines extend and in two or more columns in a direction that the scan lines extend, wherein the data line driving circuit has a demultiplexer having a plurality of output terminals relative to one input terminal and connecting a selected output terminal of the plurality of output terminals to the input terminal so that it distributes image signals supplied as time division signals to the data lines.

2. The electro-optical device according to claim 1, further comprising a scan line driving circuit supplying scan signals sequentially to the scan lines, wherein each of the plurality of pixels is constituted by the sub-pixels arranged in two columns in the direction that the scan lines extend, wherein the scan line driving circuit supplies scan signals at a duty ratio of twice that in the case of the plurality of pixels having the sub-pixels arranged in one column in the direction that the scan lines extend.

3. The electro-optical device according to claim 2, wherein the scan line driving circuit supplies the scan signals at 120 Hz.

4. A method of driving an electro-optical device having a display region constituted by a plurality of pixels that is constituted by a plurality of sub-pixels each displaying different monochromes, the sub-pixels having scan lines, data lines, pixel electrodes and a switching element arranged at intersections of the scan lines and the data lines, the method comprising:
forming the plurality of pixels by arranging the sub-pixels in two or more rows in a direction that the data lines extend and in two or more columns in a direction that the scan lines extend;
making one column as a first sub-pixel group and the other column as a second sub-pixel group among the sub-pixels in two columns arranged in a direction that the scan lines extend;
supplying scan signals to the scan lines to make switching elements associated with the first sub-pixel group enter a conducting state and in this state, supplying image signals to the data lines to supply the image signals to pixel electrodes associated with the first sub-pixel group; and
supplying scan signals to the scan lines to make switching elements associated with the second sub-pixel group enter a conducting state and in this state, supplying image signals to the data lines to supply image signals to pixel electrodes associated with the second sub-pixel group.

5. The method of driving an electro-optical device according to claim 4, further comprising:
constituting each of the plurality of pixels by arranging the sub-pixels in two columns in a direction that the scan lines extend, during supply of the image signals to pixel electrodes in the first sub-pixel group and the second sub-pixel group; and
supplying scan signals during supply of image signals to pixel electrodes in the first sub-pixel group and the second sub-pixel group at a duty ratio of twice in writing that in the case in which each of the plurality of pixels are formed by arranging the sub-pixels in one column in the direction that the scan lines extend.

6. An electronic apparatus having the electro-optical device according to claim 1.
